(19) United States
(12) Patent Application Publication
(10) Pub. No.: US 2002/0033138 A1
(43) Pub. Date: Mar. 21, 2002

(54) Animal-milking system useful for milking large herds

(76) Inventor: Eyal Brayer, Kfar Monash (IL)

Correspondence Address: DR. MARK FRIEDMAN LTD., c/o Bill Polkinghorn - Discovery Dispatch, 9003 Florin Way, Upper Marlboro, MD, 20772, US

(21) Appl. No.: 09/776,872

(22) Filed: Feb. 6, 2001

(30) Foreign Application Priority Data
Sep. 17, 2000 (IL) 138514

(51) Int. Cl. A01J 3/00

(52) U.S. Cl. 119/14.03

(57) ABSTRACT

An animal-milking system exceptionally suitable for the milking of large herds based on an animal-milking carrousel that can be configured to operate without human intervention. A rotating platform with animal-milking stalls disposed around the edge of the platform is provided. A teat-cup attaching area, equipped with one or more teat-cup attaching robots, is located so as to attach teat-cups to animals confined in milking stalls when the animals are brought into proximity with the robots. By allowing a plurality of animals to board the carrousel simultaneously, and by extending the time each stall is available for boarding, efficient use of the teat-cup attaching robots is possible. Using existing technologies a carrousel with 32 stalls can automatically milk a herd of more than 1100 animals.

### FIELD AND BACKGROUND OF THE INVENTION

The present invention relates to the milking of animals and more particularly, to an animal-milking system, based on a rotating animal-milking platform, that allows a significant increase in efficiency with which large herds of animals are milked.

The pastoral scene of a milkmaid manually milking a cow into a galvanized bucket is no longer a reality of the dairy industry. Large-scale industrialized milking methods are the norm. A plethora of advanced technologies have been developed and are used to supply the needs of the world population.

Increased use of technology has made the milking of an individual animal very efficient. Most important are milking teat-cups based on vacuum pumps which have replaced the milkmaid. Technologies that perform advanced functions have been developed: udder cleaning, teat-cup attachment, udder stimulation, all can be done by machine. Systems capable of individual animal identification, coupled with computerized control of the steps making up the milking process, allow individual treatment of an animal within an automated process (for example, U.S. Pat. No. 4,508,058 or U.S. Pat. No. 3,557,758).

The combination of these technologies allows the construction of systems in which an animal can decide to enter the milking system of its own volition, leading to fully automated cow-milking systems. Using fully automated systems, farmers are not bound to a strict schedule and are free to perform other essential tasks.

As a result of advanced milking technologies, the method of moving of the herd through the milking process has become the bottleneck to efficient milking, especially of large herds. To increase milking throughput of a herd, various systems have been developed.

Fully automated systems for milking animals have been described. European Patent Applications EP 0990385A2 and EP 1042952A2 provide constructions made up of two milking stalls arranged as a set, serviced by one milking robot and one udder-cleaning robot. During the time that an animal in a first milking stall is being milked, a second animal is led into the second milking stall and prepared for milking. These two systems, however, are suitable only for milking small herds.

A popular method to milk the animals of a herd is typified by the use of a “carrousel” milking structure 20 in FIG. 1. As its name suggests, this structure consists of many milking-stalls arranged on rotating platform 22. Each stall, e.g. 24, has an appropriate number of associated teat-cup. The animals board the carrousel one at a time and are confined in a milking stall. Most often platform 22 rotates continuously, although step-wise rotation has been implemented. At some point, a farm hand attaches the teat-cups to an animal confined in a stall. As the animal travels around on the carrousel, it is milked. Once the udder of the animal is empty, the teat-cups automatically disengage from the udder. At another point thereafter, the animal can debark from the carrousel. Often, stations are added at appropriate points around the carrousel to perform certain actions, such as udder stimulation or feed dispensing.

Optimization of a carrousel-based method is a complex. Although in principle unlimited, the maximal size of a carrousel is limited by considerations of scaling costs, dead time (time that an animal rides the carrousel after being milked) and land value. The area intensive configuration of the carrousel is of minor significance in Texas or Australia, but is of primary concern where land value is high such as the Netherlands or Israel. The minimal practical size of a carrousel is determined by the 6 to 10 minute period that is necessary to milk the animal added to the overhead of animal loading, unloading and teat-cup attachment, typically 1.5 minutes per action. This means that each animal spends a total of 10 to 15 minutes on the carrousel.

On the face of it, it should be possible to fully automate carrousel-based milking systems. The advantage of full automation is in a large part neutralized by the high cost of a milking robot. Automation of a carrousel is typically achieved by adding a milking robot in every stall. A large part of the cost of a milking robot comes fIrom its udder-locating and attaching functions that are used for 1.5 minutes. The resulting 15% utilization of a milking robot in the optimal case is wasteful, rendering the use of milking robots economically not viable. This is more significant in a large carrousel where, as is clear to one skilled in the art, the greater dead-time leads to less efficient use of the milking robot. As a result, teat-cup attachment in milking carrousels is most often done manually.

U.S. Pat. No. 6,050,219 provides a fully automated animal-milking carrousel with four milking stalls, each with an associated milking robot. The small size of this system, coupled with the high-price of one robot for every stall, makes this system less useful for large herds.

U.S. Pat. No. 4,508,058 provides a milking system based on a milking-carrousel designed to be fully automated and based on a voluntary milking scheme. In the voluntary milking scheme, animals choose to board the carrousel rather than to be driven onto it. In U.S. Pat. No. 4,508,058 the carrousel is equipped with a stationary teat-cup attaching robot. The use of such a robot overcomes the high-price limitation of milking robots by concentrating the expensive functions of teat location and teat-cup attachment in one efficiently-used machine. Of their own volition, animals board the carrousel through an entrance to be confined in a milking stall with food. A computer coupled to an animal-identification system decides if the animal is to be milked. Upon boarding the carrousel, the animal is in proximity of the lone teat-cup attaching robot. At this position, if the animal is to be milked, the teat-cup attaching robot seeks the teat-cups associated with the stall wherein the animal is confined, engages them, and attaches them to the udder of the animal. Milking can then proceed for as long as the animal is confined to the stall. The animal remains confined on board the carrousel as it turns each time rotating to allow an additional animal to board.

Theoretically, it would be expected that a system as described in U.S. Pat. No. 4,508,058 could be fully automatic. Furthermore, if animal entrance, rate of rotation and actual milking-time were to perfectly mesh the expensive udder locating and teat-cup attaching functions of the robot would be used close to 100% of the time.

The primary disadvantage of the animal-milking system provided by U.S. Pat. No. 4,508.058 is that it fails to take into account the nature of animals, in particular cows. For example, an individual animal may board the carrousel more slowly than expected. If the system is based on waiting for an animal to board, this can lead to delay in the whole system, reducing efficiency of robot use. Furthermore, an animal often balks and refuses to board the carrousel. Although this balking can be for a short time, in some cases it can last for many hours. In such a situation, human intervention is required. This means that to make efficient use of the expensive robot, a worker must be nearby and available to quickly respond when an animal refuses to board. If a worker must be available in any case, it is no longer advantageous to expend the resources for the automatic teat-cup attaching robot. Paradoxically, for such a system development of quicker and more efficient teat-cup attaching robots at an increased cost is not desirable as increased robot performance gives no tangible gains. As a result, systems based on the teachings of U.S. Pat. No. 4,508,058 have not gained acceptance in the art and operation of animal-milking systems based on carrousels remains labor-intensive.

Although the problems of milking small herds are satisfactorily solved by the existing solutions, milking of large herds remains a problem. Large herds are often divided into separate groups. Separation is usually done physically, isolating each in a separate field. Whether a large herd is divided into groups or not, a solution may be to erect many isolated milking systems of the types described above, for example, in the field of a specific group. This, however, leads to problems of milk storage and transportation from the individual systems, spread out over a broad area, as well as the difficulties inherent in maintenance of many separate systems, raising the total cost of milking the herd.

Whether subdivided into groups or not, the movement of large groups of animals to a central location is a labor intensive and complex logistical task.

It would be highly advantageous to have a milking system that retains the advantages of fully automated milking but at a reduced cost relative to that of existing automated milking stalls. It would be advantageous that such a milking system have a high-throughput suitable for the milking of large herds with an absolute minimum of human intervention.

### SUMMARY OF THE INVENTION

The above and other objectives are achieved by the innovative system provided by the present invention.

There is provided according to the teachings of the present invention an animal-milking system, for the milking of a large herd of animals by milking each individual animal while the animal is confined within a milking stall, made up of a) a carrousel configured to provide a rotating platform; b) at least eight milking stalls, for at least partially confining an animal within a region adjacent to the edge of the rotating platform; c) teat-cups associated with each milking stall; d) a teat-cup attaching area designated at one edge of the carrousel; e) an entrance area designated at one edge of the rotating platform, the entrance area being wide enough to allow simultaneous entrance of a plurality of the animals to at least two of the milking stalls; and f) an exit area designated at one edge of the rotating platform, the exit area being wide enough to allow simultaneous exit of a plurality of the animals confined in at least two of the milking stalls wherein the confined animals have been milked.

According to a further feature of the present invention the milking stalls of the carrousel are subdivided into sets, each set made up of at least two stalls, and the designated exit and entrance area are as wide as least one such set, so as to allow simultaneous exit or entrance of animals into a plurality of sets.

According to a further feature of the present invention, the teat-cup attaching area includes at least one and no more than half the number of stalls of teat-cup attaching robots.

According to a further feature of the present invention, the teat-cup attaching robots are configured to attach the teat-cups to the animals to be milked by entering between the two hind legs of the animal.

According to a further feature of the present invention, the teat-cup attaching robot identifies the udders or teats of the animal to be milked by identifying some mark put on the animal for that purpose. According to a still further feature of the present invention, such a mark is paint, that is for example, a liquid, cream or lotion with a distinctive characteristic such as a color or fluorescence, to simplify identification of the udder or teat by the teat-cup attaching robot.

According to a further feature of the present invention, the milking stalls of the carrousel are subdivided into sets, each set made up of at least two stalls, and the teat-cup attaching area includes at least two teat-cup attaching robots.

According to a further feature of the present invention, the milking stalls of the carrousel are subdivided into sets, each set made up of at least two stalls, and the teat-cup attaching area includes a number of teat-cup attaching robots equal to the number of milking stalls that make up each set.

According to a further feature of the present invention the entrance and exit areas are equipped with a moveable closing means such as gates configured to separate the entrance and exit areas from stalls adjacent to these areas, preventing animal movement between the stalls and the respective areas.

According to a further feature of the present invention, each stall is supplied with a separately-operable moveable closing means such as a gate and a computer-controlled system is configured to actuate each of the closing means separately.

According to a further feature of the present invention, each stall in proximity of the entrance area is supplied with a separately-operable moveable closing means such as a gate and a computer-controlled system is configured to actuate each of the closing means separately.

According to a further feature of the present invention, there are guiding means, such as an arrangement of gates and fences, overpasses and underpasses deployed so as to delineate a plurality of paths to control movement of the animals over paths and between areas comprising the animal-milking system.

According to a further feature of the present invention, these guiding means are deployed so as to divide the herd into a plurality of groups of animals, each group being isolated in a separate field and the course taken by each animal from one field through the entrance area, onto the carrousel, through the exit area and back to its field is determined by the guiding means.

According to a further feature of the present invention there is an animal identification system configured to uniquely identify each of the animals.

According to a further feature of the present invention there is a supplied a means to effect step-wise rotation of the rotating platform in a step-wise fashion.

According to a further feature of the present invention, the milking stalls are arranged in sets, each set comprising at least two milking stalls, and one step of rotation is of a magnitude equivalent to a multiple of a width of one set of milking stalls.

According to a further feature of the present invention each step of rotation is initiated by a computer-controlled system.

According to a further feature of the present invention, initiation of each rotation step occurs at a fixed time interval.

According to a still further feature of the present invention the rotating platform is annular, having an inner edge and an outer edge.

### BRIEF DESCRIPTION OF THE DRAWINGS

The invention is herein described, by way of example only, with reference to the accompanying drawings, wherein:

FIG. 1 (prior art) is a schematic top view of an animal-milking system based on an animal-milking carrousel;

FIGS. 2a through 2d are schematic top views of an animal-milking system as provided by the present invention and its use; and

FIG. 3 is a schematic top view of an additional embodiment of an animal-milking system as provided by the present invention.

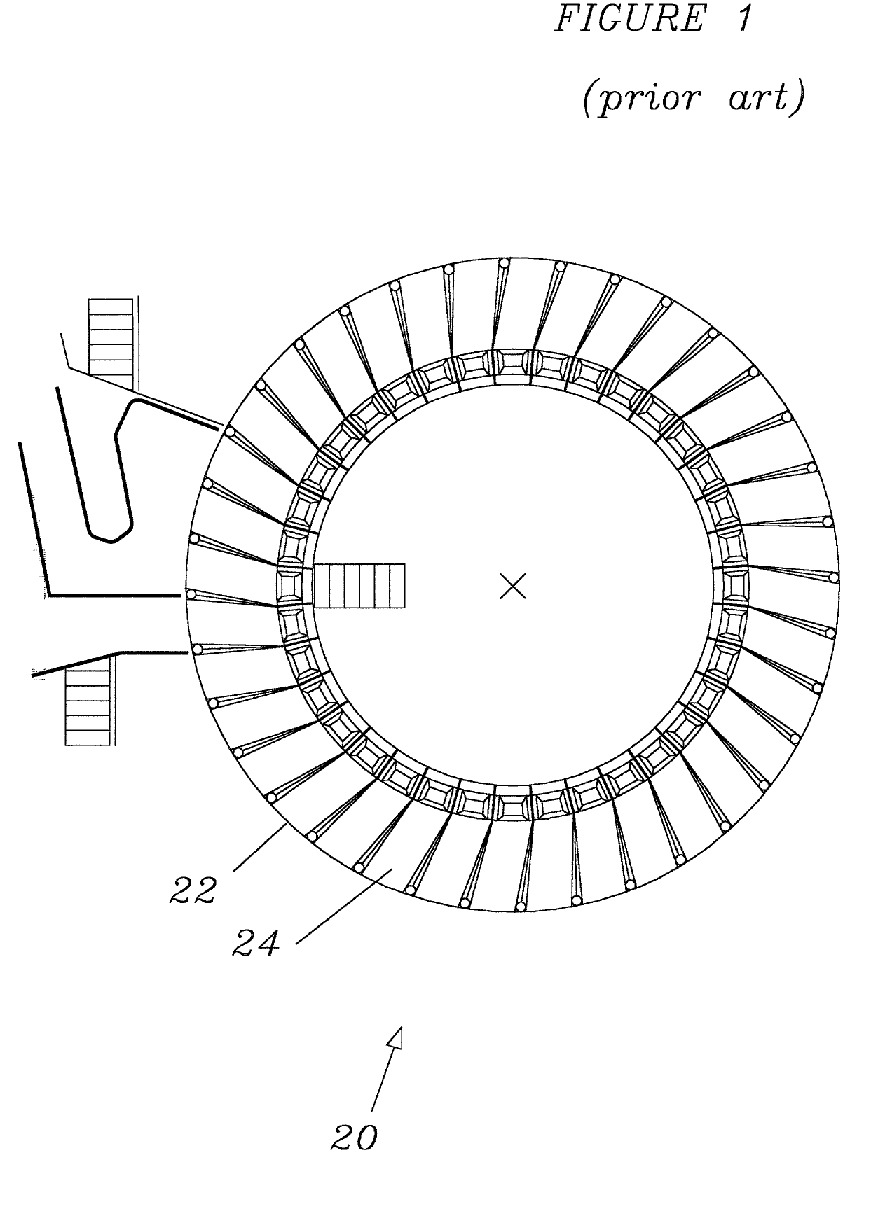

### DESCRIPTION OF THE PREFERRED EMBODIMENTS

The present invention is an innovative animal-milking system, which allows a significant increase in efficiency of the milking of large herds of animals. By allowing a plurality of animals to board and debark from the cow-milking platform (the carrousel) of the invention and by using teat-cup attaching robots, an unpredictably useful and efficient system is attained. The system can function fully automatically and allows efficient milking of large herds, something hitherto unknown in the art.

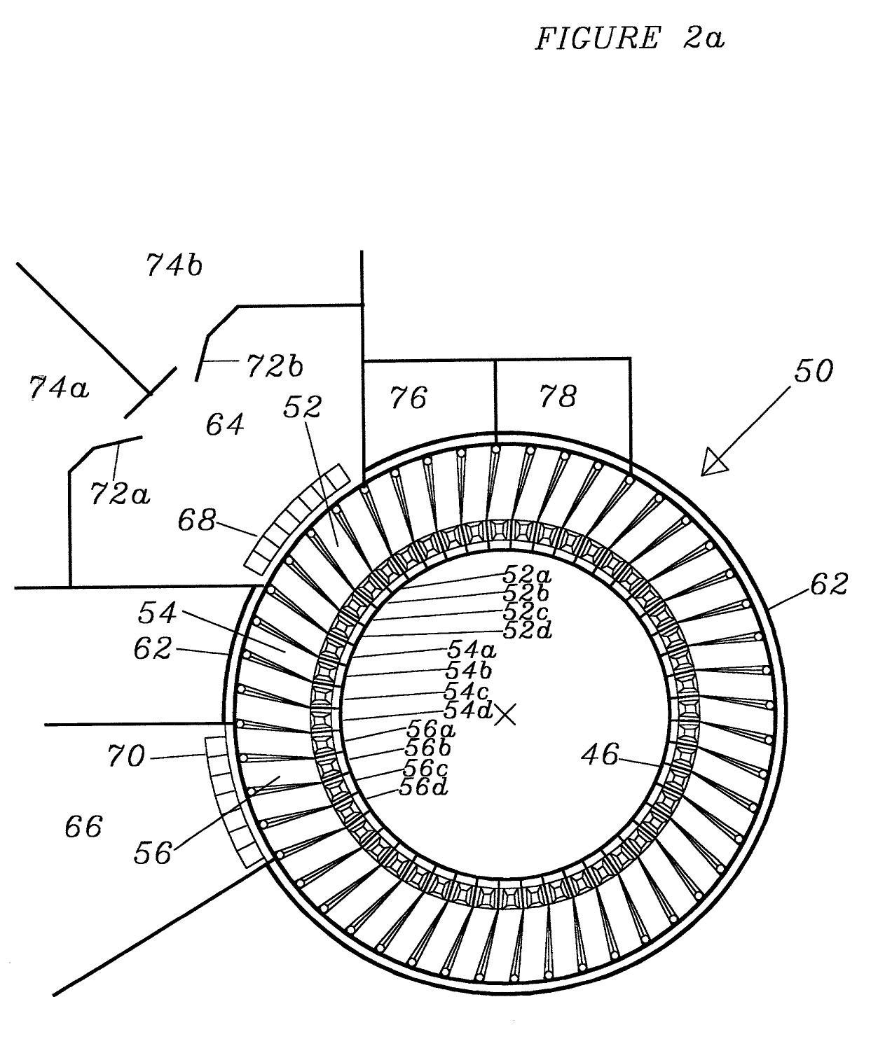

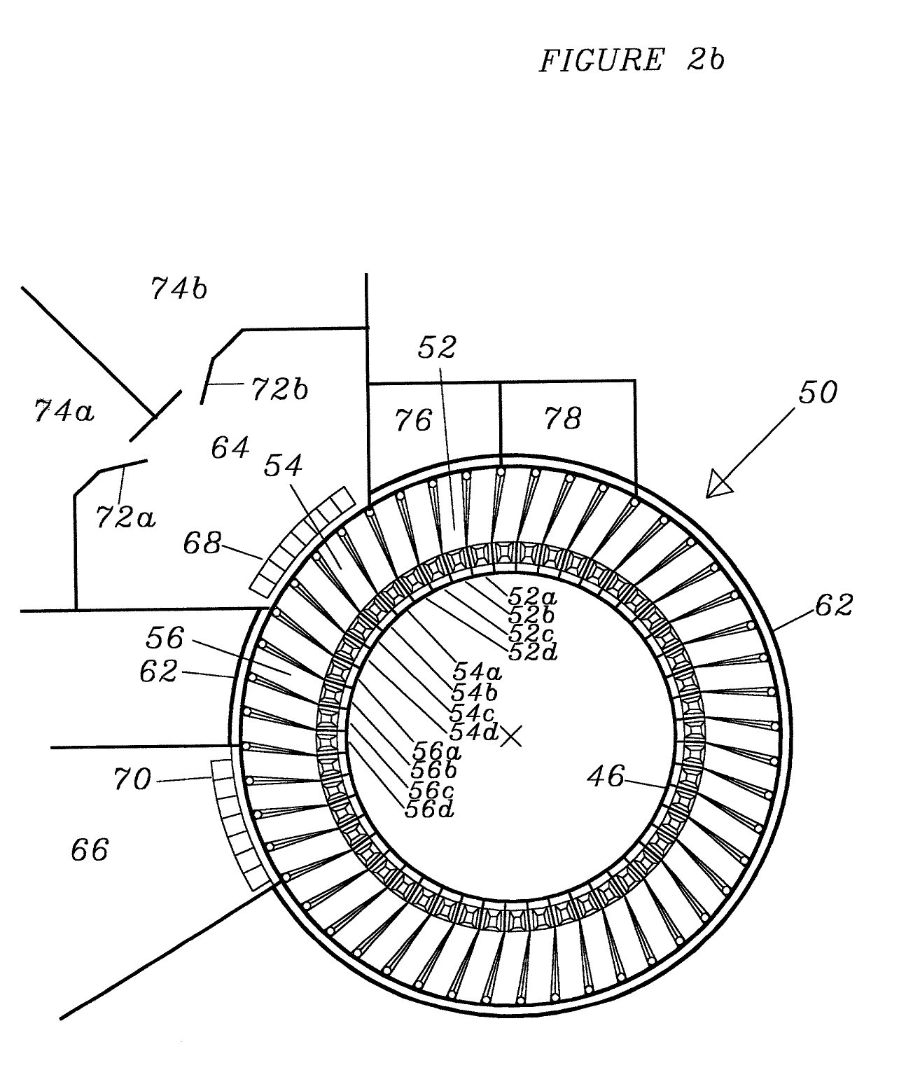

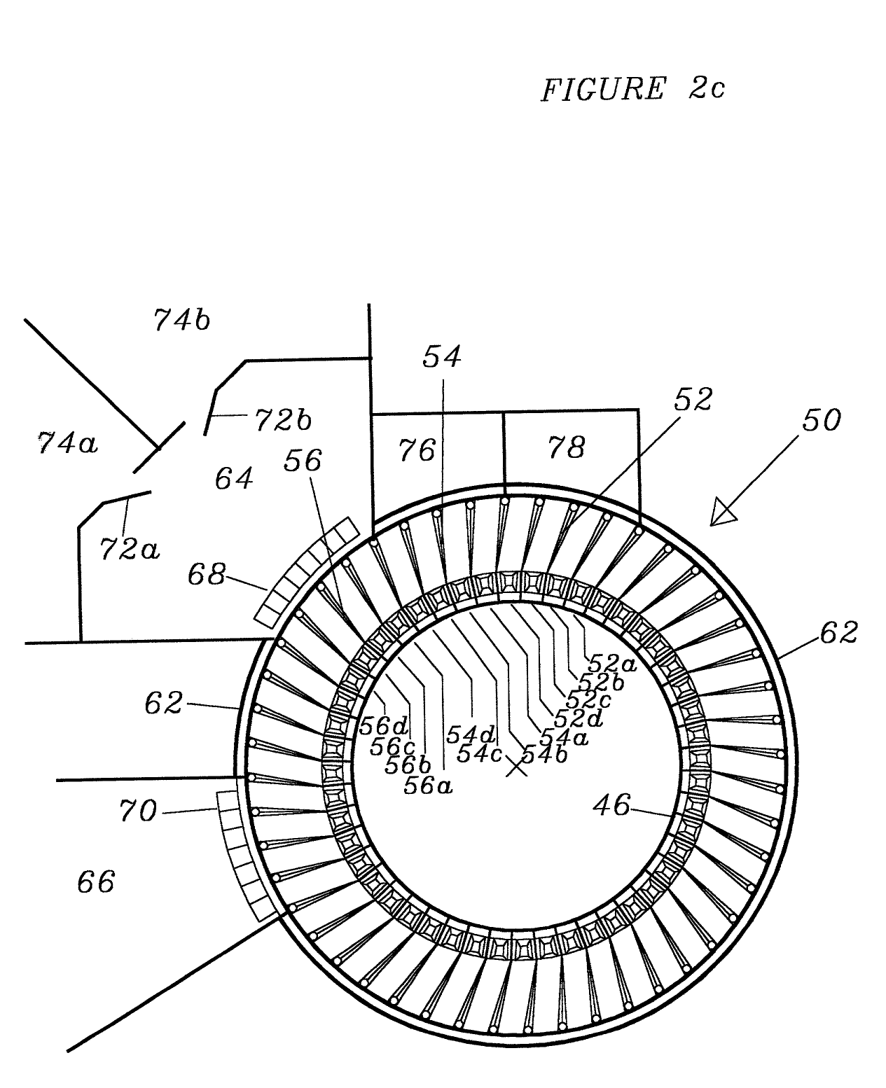

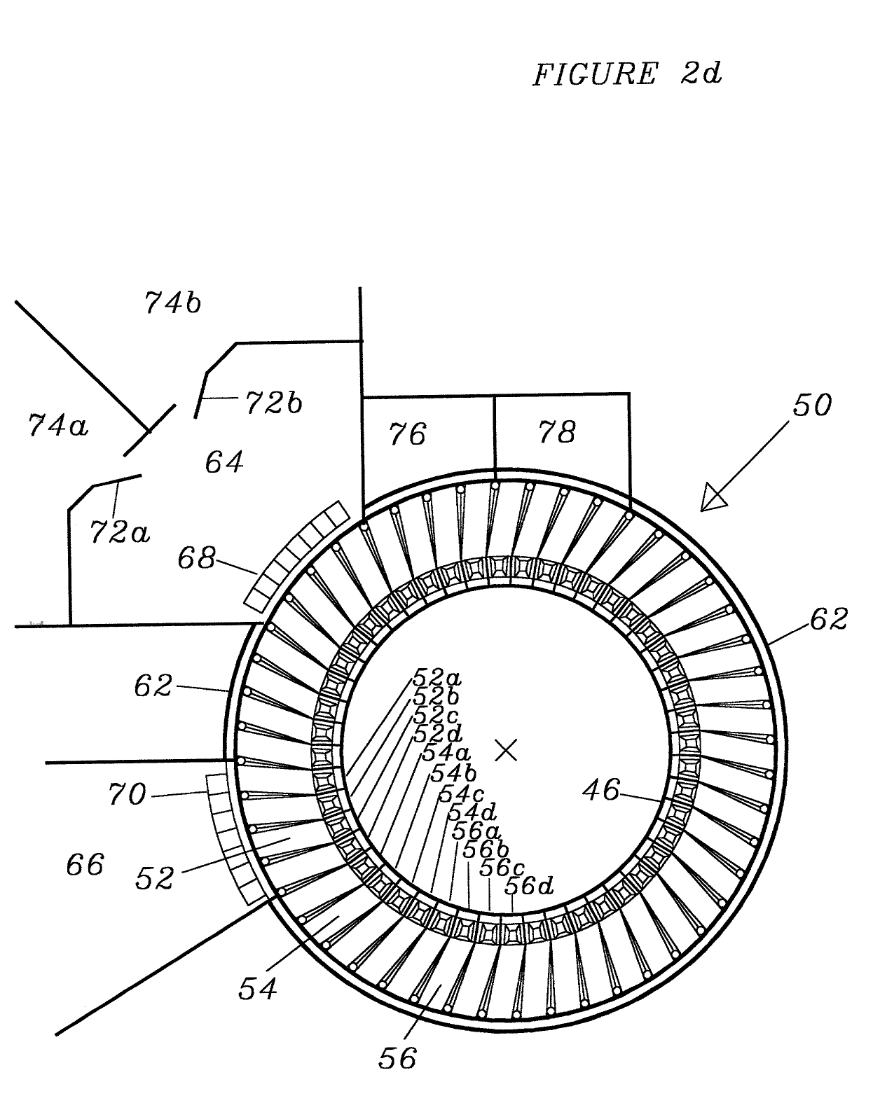

The principles and operation of a system according to the present invention may be better understood with reference to the drawings and the accompanying description. The use of the animal-milking system of the present invention can best be understand with reference to FIGS. 2a through 2d.

The rotating platform itself is typically annular or disk-shaped with a plurality of milking stalls arranged around its perimeter. The primary advantage of the annular over the disk-shape is that an annular rotating platform there is an inner and outer edge, allowing greater design flexibility.

A set of milking stalls as used herein defines a group of milking stalls, composed of two or more individual stalls, up to a maximum of half of the stalls on the carrousel.

In one embodiment of the system of the present invention, a teat-cup atarea is configured to allow manual attachment of teat-cups to the udders of animals confined in stalls adjacent to the teat-cup attachment area. In a preferred embodiment of the system of the present invention, there are one or more teat-cup attaching robots in the teat-cup attachment area. In the most preferred embodiment of the present invention the number of teat-cup attaching robots is equal to the number of milking stalls which make tip one set of milking stalls.

The teat-cup attaching robot of the present invention is configured to autonomously identify the udder of an animal confined in a milking stall and to attach the teat-cups thereto, to disengage from the teat-cups once the teat-cups are attached to the udder of the animal, and to withdraw in such a way as to not interfere with carrousel rotation. Furthermore, the teat-cup attaching robot of the present invention is also configured to identify the teat-cups in the milking stall when an animal is in the stall and the teat-cups are not attached, engage the teat-cups, for example by grasping, in such a way as to allow subsequent attachment of the teat-cups to the udder of the confined animal. Such a teat-cup attaching robot is known in the art, see for example U.S. Pat. No. 4,508,058.

Unlike in the prior art, a plurality of animals is allowed to board and debark simultaneously. This is effected by defining an entrance area that spans two or more stalls or at least one set of milking stalls, and an exit area that spans two or more stalls or at least one set of milking stalls. In many cases it is advantageous to define the entrance and exit areas to span more than one set of milking stalls.

Although the system of the present invention provides for continuous rotation of the carrousel, it is advantageous to perform step-wise rotation of the carrousel, preferably where each step rotates the carrousel by a distance equivalent to a multiple of a width of a set, and even more preferably by a distance equivalent to an integral multiple of a width of a set. The choice of continuous or step-wise rotation is influenced by the capabilities of the other elements of the milking-system particularly of the teat-cup attaching robots. In the art it is accepted that continuous rotation necessitates that the robots be able to move with the carrousel motion by, for example, by swiveling or sliding on rails. Step-wise rotation allows the use of substantially statically mounted robots.

The present invention also provides for a plurality of paths delineated by guiding means, such as gates or fences and possibly including overpasses and underpasses. By using the guiding means, it is possible to guide the animals from the field where they are grazing, to the entrance area, onto the carrousel, and after debarking, to direct them from the exit area back to the field from which they came.

It is clear to one skilled in the art, that the efficiency of the system and full automation can be achieved by the use of slightly modified versions of computer-based control systems known in the prior art. Of prime importance is the control of the guiding means to ensure that animals from one group isolated in one field return to that field. It is clear, however, that a computer-based control system can be configured to control many and varied elements of the animal-milking system.

It is also clear to one skilled in the art that it is highly advantageous to integrate an animal-identification means with the system of the present invention. This allows for individualized treatment of the animal, such as determining milking frequency or feed choice or directing individual animals with the help of the automatic guiding means. With an animal-identification means it is also possible to institute voluntary milking of animals, specifically for animals from different groups which compose a herd.

To further clarify the use of the system of the present invention, an embodiment for the milking of a herd of cows will be described with reference to FIGS. 2a through 2d and the succeeding description.

In FIG. 2, animal-milking carrousel 50 of the invention is illustrated in a configuration to allow fully automated milking of a herd separated into two groups. Rotating platform 46 of carrousel 50 is annular, with 48 milking stalls divided into twelve sets of four milking stalls each. Not pictured is that each stall is equipped with the appropriate number of teat-cups. In FIGS. 2a through 2d, set 52 is composed of stalls 52a, 52b, 52c and 52d, set 54 is composed of stalls 54a, 54b, 54c and 54d, and set 56 is composed of stalls 54a, 56b, 56c and 56d. Each stall is delineated by three sides attached to the platform, confining an animal therein on three sides. Wall 62 15 extends around the outer edge of rotating platform 46, excepting entrance area 64 and exit area 66. Wall 62 prevents an animal from leaving the stall unless the stall is found at entrance area 64 or exit area 66. Entrance gate 68 extends across the stalls at entrance area 64 and exit gate 70 extends across the stalls at exit area 66. When gates 68 and 70 are closed animals in stalls adjacent to entrance area 64 and exit area 66 (52a, 52b, 52c, 52d, 56a, 56b, 56c and 56d in FIG. 2a ) are confined in the stalls and cannot exit. When gates 68 and 70 are open, an animal in the stall can exit to or enter from areas 64 and 66, respectively. Gates 72a and 72b separate the entrance area from fields 74a and 74b, respectively. Udder cleaning area 76 is equipped with four udder-cleaning robots. Teat-cup attachment area 78 is equipped with four teat-cup-attaching robots. Rotating platform 46 is configured to rotate in a step-wise fashion 30 degrees every step, a step that is equivalent in size to the width of one set.

Initially (FIG. 2a), when rotating platform 46 is static, entrance gate 68 and gate 72a are open whereas all other gates are closed. Cows held in field 74a are driven into entrance area 64. Four cows are driven onto platform 46 into stalls 52a, 52b, 52c and 52d making up set 52. Entrance gate 68 is closed.

Thereafter rotating platform 46 is rotated 30 degrees in a clockwise direction and entrance gate 68 is opened (FIG. 2b). Set 52 is adjacent to udder-cleaning area 76 whereas set 54 is adjacent to entrance area 64. While a further four cows are driven into stalls 54a, 54b, 54c and 54d making up set 54 the udders of the cows confined in set 52 are washed. Entrance gate 68 is closed.

Thereafter, platform 46 is again rotated 30 degrees in a clockwise direction, bringing set 52 adjacent to teat-cup attachment area 78, set 54 adjacent to udder-cleaning area 76 and set 56 adjacent to entrance area 64 (FIG. 2c). While a further four cows are driven into stalls 54a, 56b, 56c and 56d making up set 56, the udders of the cows confined in set 54 are washed, and each of the four teat-cup attaching robots identifies one of the teat-cups associated with stalls 52a, 52b, 52c and 52d, engages the teat-cup, attaches the appropriate teat-cup to the animal confined in each of stalls 52a, 52b, 52c and 52d, disengages the respective teat-cup, and withdraws so as not to interfere with subsequent rotation of platform 46 (FIG. 2d). Entrance gate 68 is closed. It is clear to one skilled in the art that in this embodiment of the present invention, the teat-cup attaching robots attach the teat-cups to the animals by entering between the two hind legs of the animals confined in the stall.

During subsequent rotations, each four cows confined in each set pass the areas as described above. After teat-cup attachment, the cows confined in stalls 52a, 52b, 52c and 52d of set 52 are milked. When no milk remains in the udder of any one individual animal, the teat-cup disengages the udder. The cow continues to ride on the carrousel until set 52 arrives adjacent to exit area 66 (FIG. 2d). Exit gate 70 opens, allowing the cows confined in stalls 52a, 52b, 52c and 52d of set 52 to debark to exit area 66. The cows are thereafter directed by a series of gates and fences (not illustrated) back to field 74a.

Assuming that each activity (boarding, udder cleaning, teat-cup attachm, debarking) takes 1.5 minutes, the carrousel of FIG. 2 allows twelve minutes of actual milking. More importantly, the teat-cup attaching robots are utilized with near unit efficiency. In one embodiment of the present invention, rotation is initiated under control of a computer after an action such as animal entrance have been completed. In a preferred embodiment of the invention, rotation is initiated at fixed time intervals. Most preferably, the fixed time intervals correspond to substantially the time required by the teat-cup attaching robot to perform its task and withdraw.

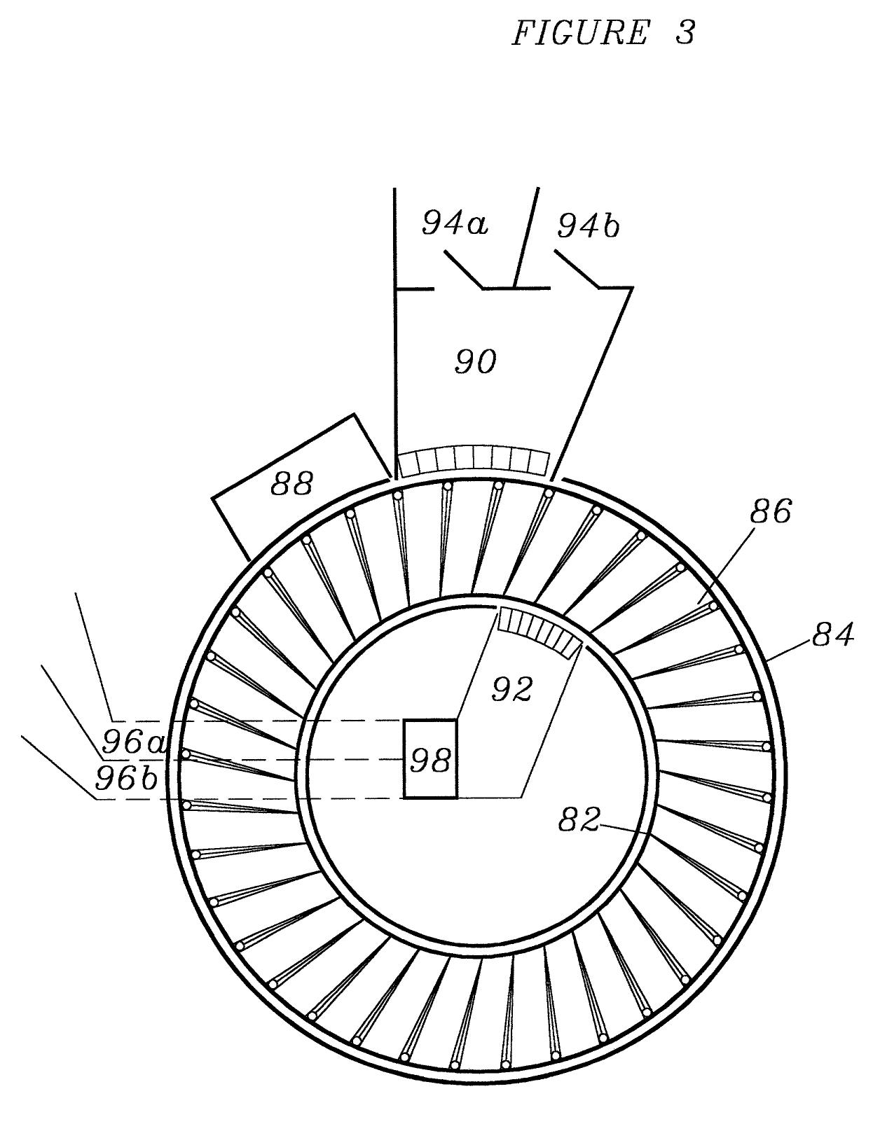

In FIG. 3 an additional embodiment of the present invention is illustrated, wherein the 24 individual stalls are arranged at an angle relative to the radii of annular rotating platform 86, allowing teat-cup attaching robots in teat-cup attachment area 88 to attach the teat-cups from the side of a confined animal and not from between the two hind legs of the animal. Two sides attached to platform 86 delineate each stall. Wall 84 extends around the outer edge of rotating platform 86, excepting entrance area 90. Wall 82 extends around the inner edge of rotating platform 84, excepting exit area 92. The carrousel is divided into eight sets of three stalls each. Whereas entrance area 90 is arranged on the outside of rotating platform 86, exit area 92 is arranged on the inner side of rotating platform 86. Milked cows travel from exit area to the appropriate fields 94a or 94b by passing through underpasses 96a and 96b, respectively, via cow-washing machine 98. The rotation of platform 86 is in a counter-clockwise direction.

The manner of usage and operation of the milking-system in FIG. 3 is, in analogy to the system illustrated in FIG. 2, apparent to one skilled in the art. Accordingly, no further discussion relating to the manner of usage and operation will be provided.

As is often the case, an animal may balk and refuse to board the carrousel. As a result of the innovative integration of an entrance area that allows a plurality of animals to board the carrousel simultaneously, a balking animal does not shut-down the system nor require immediate intervention. Rather, other animals board and the occupancy of the carrousel is only temporarily reduced. In the case of the carrousel of FIG. 2 carrousel occupancy, and as a consequence teat-cup attaching robot use, remains 75%. Furthermore, the balking animal sees that other animals enter the carrousel. As it is a herd animal, the continuous movement of other animals alongside can cause the balking animal to board the carrousel of its own accord, solving the problem with no human intervention.

In an additional embodiment of the invention (not illustrated), the entrance area spans more than one set of milking stalls while the magnitude of one step of rotation remains one set. Typically, each stall is then available for animal entrance for a longer time, increasing the chance of stall occupancy. The chance that a given stall shall remain empty due to a balking animal blocking the stall entrance at both the first and the following stop is insignificant. The combination of avoiding balking animals and an extended boarding time almost guarantees continuous maximal occupancy. In this embodiment it is advantageous that each stall have an associated closing means such as a gate to prevent animals that have boarded from debarking while the stall is still adjacent to the entrance area. Each such associated closing means is activated to prevent animal exit by the presence of the animal inside a respective milking stall and is advantageously controlled by an appropriately configured computer based system.

The issue of occupancy can best be understood by a numerical example. In an ideal situation, a typical teat-cup attaching robot requires 1.5 minutes to attach the teat-cups to an animal confined in a milking stall on the carrousel. To guarantee maximal use of the robot, the carrousel must rotate every 1.5 minutes to bring a new animal in proximity with the robot. 1.5 minutes may not be enough time to allow an animal to board or debark so that, in every rotation, not every stall is occupied. Typically, 1.5 minutes allow a stall to be occupied 85% of the time. By making a plurality of stalls of the carrousel available for simultaneous animal entrance overall carrousel occupancy remains 85%, but problems resulting from animal balking are reduced. However, by doubling the size of the entrance area and keeping the rotation step size unchanged, each stall is accessible for 3.0 minutes so overall occupancy reaches 98%.

In addition, the milking system of the present invention is not adversely affected by the development of quick teat-cup attachment robots. Faster-acting robots require only modification of the number of stalls comprising a set and the size of the entrance area in accordance with the present invention.

Assuming a six-minute milking period and 1.5 minute attaching time, a carrousel with 8 milking stalls, divided into sets of one stall each, equipped with one teat-cup attaching robot and an entrance area that spans two sets is the minimal configuration which retains all of the advantages of the present invention. Such a carrousel can be shown to be able to perform 840 milkings in 21 hours, enough for a 280-head herd. However, as the main purpose of the carrousel of the invention is to enable efficient milking of large herds, larger configurations are envisioned. It is clear to one skilled in the art, that a cow milking system of the present invention with 32 stalls can milk a herd of in excess of 1100 head.

One skilled in the art can easily modify the present invention as described hereinbefore by integrating features that are well known in the art. Features such as automatic feed and drink dispensing to food troughs in each individual milking stall are a prime example. The designation of further areas around the perimeter of the carrousel such as udder or animal washing performed manually or with the aid of robots can be easily done. Importantly, such additions do not reduce the efficiency of use of the expensive teat-cup attaching robots.

It is clear to one skilled in the art that the system of the present invention can with appropriate modifications, be used to milk herds of cows, sheep, goats, lamas and buffalo.

It is clear to one skilled in the art that previously described improvements and future advancements in milking can easily be integrated into this invention. It is therefore clear that the invention is not limited to the embodiments described herein but also relates to all kinds of modifications thereof, insofar as they are within the scope of the claims.

What is claimed is:

1. An animal-milking system, for the milking of a large herd of animals by milking each individual animal while the animal is confined within a milking stall, comprising:
a. a carrousel configured to provide a rotating platform with at least one edge;
b. at least eight milking stalls, the milking stalls each configured for at least partially confining an animal within a region of said rotating platform adjacent to a said edge;
c. teat-cups associated with each of said milking stalls;
d. a teat-cup attaching area designated at at least one said edge over no more than half of a perimeter of said carrousel;
e. an entrance area designated at at least one said edge of said rotating platform, said entrance area having a width sufficient to allow simultaneous entrance of a plurality of the animals to at least two of the milking stalls; and
f. an exit area designated at at least one said edge of said rotating platform, said exit area having a width sufficient to allow simultaneous exit of a plurality of the animals confined in at least two of the milking stalls wherein the confined animals have been milked.

2. The animal-milking system as in claim 1 wherein the milking stalls are arranged in sets, each said set comprising at least two of the milking stalls and the width of said entrance area is sufficient to allow simultaneous entrance of a plurality of the animals to at least one of said sets of the milking stalls.

3. The animal-milking system as in claim 1 wherein the milking stalls are arranged in sets. each said set comprising at least two of the milking stalls, and wherein the width of said exit area is sufficient to allow simultaneous exit of a plurality of the animals from at least one of said sets of the milking stalls wherein the confined animals have been milked.

4. The animal-milking system as in claim 1 wherein said teat-cup attaching area includes at least one teat-cup attaching robot.

5. The animal-milking system as in claim 4 wherein said teat-cup attaching area includes a plurality, equal in number to no more than half the number of stalls, of teat-cup attaching robots.

6. The animal milking system of claim 4 wherein said teat-cup attaching robots are configured to attach said teat-cups to the animal confined within a milking stall by entering between two hind legs of the animal.

7. The animal-milking system of claim 4 wherein said teat-cup attaching robots are configured to identify a place to attach said teat-cups by identifying a mark on the animal confined within a milking stall.

8. The animal-milking system of claim 7 wherein said mark is paint on a teat of the animal confined within a milking stall.

9. The animal-milking system as in claim 4 wherein the milking stalls are arranged in sets, each said set comprising at least two of the milking stalls and wherein said teat-cup attaching area includes at least two teat-cup attaching robots.

10. The animal-milking system as in claim 9 wherein a number of said teat-cup attaching robots is equal to a number of the milking stalls making up each of said sets.

11. The animal-milking system as in claim 1 wherein said entrance area is equipped with a moveable closing means separating said entrance area from milking stalls adjacent to said entrance area.

12. The animal-milking system as in claim 1 wherein said exit area is equipped with a moveable closing means separating said exit area from milking stalls adjacent to said exit area.

13. The animal-milking system as in claim 1 further comprising:
g) separately-operable moveable closing means for each said stall; and
h) a computer-controlled system configured to actuate each of said moveable closing means separately.

14. The animal-milking system as in claim 1 further comprising:
g) separately-operable moveable closing means for each said stall in proximity of said entrance areas; and
h) a computer-controlled system configured to actuate each of said moveable closing means separately.

15. The animal-milking system as in claim 1 further comprising guiding means delineating a plurality of paths to control movement of the animals over said paths between areas comprising the animal-milking system.

16. The animal-milking system as in claim 15 wherein said guiding means include an arrangement of gates and fences.

17. The animal-milking system as in claim 15 wherein said guiding means include at least one from the group comprising overpasses and underpasses.

18. The animal-milking system as in claim 15 wherein said guiding means are deployed so that the herd is divided into a plurality of groups of said animals, each said group isolated in a separate field and said course taken by said animals of said group from said field through said entrance area, onto said milking carrousel, through said exit area and back to said field is determined by said guiding means.

19. The animal-milking system as in claim 1 further comprising an animal identification system configured to uniquely identify each of the animals.

20. The animal-milking system of claim 1 further comprising means for rotating said rotating platform in a step-wise fashion.

21. The animal-milking system of claim 20 wherein the milking stalls are arranged in sets, each said set comprising at least two of the milking stalls, and a step of said step-wise rotation is of a magnitude equivalent to a multiple of a width of one of said sets of milking stalls.

22. The animal-milking system of claim 20 further comprising a computer-controlled system configured to initiate each step of said step-wise rotation.

23. The animal-milking system of claim 20 wherein said means for rotating said rotating platform in a step-wise fashion are further configured to initiate successive steps of said step-wise rotation at equal time intervals.

24. The animal-milking system of claim 1 wherein said rotating platform is substantially annular having an inner edge and an outer edge.
